(19) United States
(12) Patent Application Publication
(10) Pub. No.: US 2024/0150682 A1
(43) Pub. Date: May 9, 2024

(54) POLYSTYRENE AND/OR STYRENE COPOLYMERS SOLUBILIZING COMPOSITION

(71) Applicant: Rodanco B.V., Alkmaar (NL)

(72) Inventors: Halil AKTAS, Alkmaar (NL); Herman Franciscus GRONDMAN, Alkmaar (NL)

(21) Appl. No.: 18/280,832

(22) PCT Filed: Mar. 15, 2022
(86) PCT No.: PCT/NL2022/050139

§ 371 Date: Sep. 7, 2023

(30) Foreign Application Priority Data
Mar. 16, 2021 (NL) 2027759

(51) Int. Cl. C11D 7/50; C11D 1/28; C11D 1/34; C11D 1/66; C11D 3/43; C11D 7/26; C11D 7/32

(52) U.S. Cl. CPC C11D 7/5013; C11D 1/28; C11D 1/345; C11D 1/667; C11D 3/43; C11D 7/261; C11D 7/263; C11D 7/3209; C11D 2111/10; C11D 2111/44

(57) ABSTRACT

A composition for solubilizing polystyrene and/or styrene copolymers, including a first component and a second component, in which the first component is selected from solvents having a flashpoint of at least 25° C., and the second component is soluble in the first component. The use of the composition as a cleaning composition for the removal of polystyrene and/or styrene copolymers from a surface and a method for the removal of polystyrene and/or styrene copolymers from a surface.

The present invention relates to a composition for solubilizing polystyrene and/or styrene copolymers, such as acrylonitrile-butadiene styrene (ABS) resins, styrene-acrylonitrile (SAN), acrylonitrile-styrene-acrylate (ASA), styrene-butadiene (SB)-latexes, styrene-butadiene rubber (SBR). The present invention further relates to the use of the composition as a cleaning composition for the removal of polystyrene and/or styrene copolymers from surfaces of, for example, tools, conduits and/or storage containers, used in the polymerisation industry, e.g. the petroleum, petrochemical or plastics industry. The present invention further relates to a method for the removal of polystyrene and/or styrene copolymers from a surface.

Various solvents have been used for decades and are still used nowadays in cleaning residues generated as a result of polymerisation processes applied in the polymerisation industry, e.g. in the production of petrochemical and/or plastic components and/or compositions. It is well-known that certain solvents and solvent combinations which were once accepted as useful have come under scrutiny and increasing regulation by agencies at various levels of government for the health and environmental risks they pose. Accordingly, workers have continually desired to discover new solvents and solvent combinations capable of exerting adequate solvency characteristics on a variety of residues for the removal of such residues with at least the same degree of convenience as exhibited by the previously employed solvents.

In particular, the removal of polystyrene and/or styrene copolymers residues is known to be challenging. Hard chunks or solid deposits of polystyrene and/or styrene copolymers residues are difficult to remove from industrial installations and systems (polymerisation installations, such as storage tanks, reaction chambers, conduits, transport pipes, and the like) and relevant surfaces. Polystyrene and/or styrene copolymer cleaning composition commercially used entails necessary safety restrictions and are considered unsafe due to low flash points of the compositions used. For example, polystyrene is known to dissolve in acetone having a low flash point of −20° C. Alternatively toluene may be used, but toluene has a low flash point as well, i.e. a flash point of 4° C. It is further known that polystyrene and/or styrene copolymer dissolves in chlorinated solvents. However, due to the toxicity of chlorinated solvents, such solvents are not suitable as cleaning agents.

In order to provide an environmental friendly and safe composition suitable for solubilizing polystyrene and/or styrene copolymers, the present invention provides hereto a composition for solubilizing polystyrene and/or styrene copolymers, such as acrylonitrile-butadiene styrene (ABS) resins, styrene-acrylonitrile (SAN), acrylonitrile-styrene-acrylate (ASA), styrene-butadiene (SB)-latexes, styrene-butadiene rubber (SBR), comprising a first component and a second component, wherein the first component is selected from the group consisting of solvents having a flashpoint of at least 25 C, and wherein the second component is soluble in the first component. By providing a composition wherein the solvent having a flashpoint of at least 25° C. and wherein the second component may have a less favourable flashpoint, e.g. a flashpoint below 25 C, still a safe, user-friendly and highly effective composition may be obtained for solubilizing polystyrene and/or styrene copolymers.

In a preferred embodiment of the present invention the first component is selected from the group consisting of solvents having a flashpoint of at least 30° C., at least 35° C. or at least 40° C. Although solvents having a flashpoint of about 25° C., such as xylene, are already sufficient in providing a composition that is user friendly and safe, compositions comprising a solvent having a higher flashpoint are preferred in order to increase the safety during use of the composition even further.

It is further noted that at least the first component is selected such that at least the solvent of the composition of the present invention does not interact with the surface or material of the industrial installation to be cleaned, i.e. from which polystyrene and/or styrene copolymers have to be removed. Typically, the surface or material of the industrial installation to be cleaned is made of a metal or component or a mixture thereof. Often, the surface or material of the industrial installation is coated with one or more coatings comprising one or more materials which do not dissolve in the composition of the present invention. In general, the surface or material of the industrial installation is typically made of a metal or an alloy, stone (natural, soapstone, engineered stone, ceramic), lined (glass), coating application (abrasion resistant coatings, non-stick coatings, dry/solid lubricants, chemical resistant coatings, baked on coatings) with epoxy, fluoropolymer, molybdenum disulfide, phenolic, inorganic zinc, PTFE, PPS/Ryton, FEP, PVDF/Kynar, ECTFE/Halar, ceramic epoxy coating, and the like. The composition of the present invention is designed such, i.e. at least the first component is selected such, that the composition does not interact with the above-listed materials.

It was further found that in case the second component is selected such that the composition having a Hildebrand solubility parameter (δₕ) within the range of 17.3 MPa^{1/2} to 18.6 MPa^{1/2}, a composition is provided having excellent polystyrene and/or styrene copolymers solubility properties. It was even further found that the polystyrene and/or styrene copolymers solubility properties are further improved by providing a composition wherein the second component is selected such that the composition having a Hildebrand solubility parameter within the range of 17.6 MPa^{1/2} to 18.4 MPa^{1/2}.

It was also found that by providing a first component being the solvent and having a Hildebrand solubility parameter in the range of 15.5 MPa^{1/2} to 18.0 mP^{1/2}, a preferably a Hildebrand solubility parameter in the range of 16.0 MPa^{1/2} to 17.5 MPa^{1/2} or 16.5 MPa^{1/2} to 17.0 MPa^{1/2}, solvents may be selected having a relatively high flashpoint of at least 40° C. without negatively affecting the polystyrene and/or styrene copolymers solubility properties of the composition of the present invention. In selecting a first component having a Hildebrand solubility parameter as defined above, the second component is preferably selected from the group of first component soluble compounds having a Hildebrand solubility parameter of at least 17.0 MPa^{1/2}, preferably a Hildebrand solubility parameter of at least 17.5 MPa^{1/2}, at least 18.0 MPa^{1/2} or at least 18.5 MPa^{1/2}. It is noted that any second component may be used in order to provide a composition wherein the Hildebrand solubility parameter of the composition meets the above-defined solubility range. That is, in case a second component is used having a relatively high Hildebrand solubility parameter, the amount used of that second component may be relatively lower compared to the amount used of a second component having a relatively low Hildebrand solubility parameter.

Given the Hildebrand solubility parameters above regarding the first and second components of the composition of the present invention, it was further found that the second component may be selected such that the composition of the present invention has a solubility parameter expressed in Hansen solubility parameters (HSP) wherein:
δD is about 17.25 MPa^{1/2} to about 18.25 MPa^{1/2};
δP is about 1.0 MPa^{1/2} to about 2.5 MPa^{1/2}; and
δH is about 1.0 MPa^{1/2} to about 2.5 MPa^{1/2}.

Wherein δD is the energy from dispersion forces between molecules, δP is the energy from dipolar intermolecular forces between molecules and δH is energy from hydrogen bonds between molecules. It was further found that further increased results in solubilizing polystyrene and/or styrene copolymers may be obtained by selecting a second component having a solubility parameter expressed in Hansen solubility parameters wherein:
δD is about 17.5 MPa^{1/2} to about 18.1 MPa^{1/2};
δP is about 1.4 MPa^{1/2} to about 2.2 MPa^{1/2}; and
δH is about 1.4 MPa^{1/2} to about 2.2 MPa^{1/2}.

In selecting one or more first components serving as a solvent for the composition for solubilizing polystyrene and/or styrene copolymers, it was found that the first component is preferably selected from the group consisting of solvents having a δP and/or δH of less than 5.0 MPa^{1/2}, less than 4.0 MPa^{1/2}, less than 3.0 MPa^{1/2}, less than 2.5 MPa^{1/2}, or less than 2.0 MPa^{1/2}. In particular, it was found that a first component selected from the group consisting of solvents having a δP and δH of less than 4.0 MPa^{1/2} resulted in a polystyrene and/or styrene copolymers solubilizing composition having excellent polystyrene and/or styrene copolymers solubility properties.

In further detail, the first component is preferably selected form the group consisting of solvents having a δP of less than 3.0 MPa^{1/2}, less than 2.5 MPa^{1/2}, less than 2.0 MPa^{1/2}, less than 1.5 MPa^{1/2}, or less than 1.0 MPa^{1/2}. In addition, or alternatively, the first component is preferably selected from the group consisting of solvents having a δH of less than 5.0 MPa^{1/2}, less than 3.5 MPa^{1/2}, less than 2.0 MPa^{1/2}, less than 1.5 MPa^{1/2}, or less than 1.0 MPa^{1/2}. In further addition, or alternatively, the first component is preferably selected from the group consisting of solvents having a δD in the range of 12.5 MPa^{1/2} to 20.0 MPa^{1/2}, in the range of 14.0 MPa^{1/2} to 19.0 MPa^{1/2}, in the range of 15.5 MPa^{1/2} to 18.0 MPa^{1/2}, or in the range of 17.0 MPa^{1/2} to 18.0 MPa^{1/2}.

With regard to the second component, it was found that the second component may have a δP of at least 1.0 MPa^{1/2}, at least 3.0 MPa^{1/2}, at least 5.0 MPa^{1/2}, at least 7.0 MPa^{1/2}, or at least 8.0 MPa^{1/2}. Further, or alternatively, the second component may have a δH of at least 2.5 MPa^{1/2}, at least 3.0 MPa^{1/2}, at least 3.5 MPa^{1/2}, at least 4.0 MPa^{1/2}, or at least 4.5 MPa^{1/2}. Even further, or alternatively, the second component may have a δD in the range of 13.5 MPa^{1/2} to 21.5 MPa^{1/2}, in the range of 15.0 MPa^{1/2} to 21.0 MPa^{1/2}, in the range of 16.5 MPa^{1/2} to 20.5 MPa^{1/2}, or in the range of 17.0 MPa^{1/2} to 20.0 MPa^{1/2}.

The first component may be present in the composition of the present invention in an amount of at least 80 weight-%-%, based on the total weight of the composition. It is noted that the higher the amount of the first component present in the composition, an increase in safety and user-friendliness is obtained. Therefore, preferably the first component may be present in an amount of at least 90 weight-%, more preferably about 95 weight-%, based on the total weight of the composition.

With regard to the presence of the second component, it is noted that the amount of the second component is preferably kept as low as reasonably possible, i.e. as low as still providing a composition having a polystyrene and/or styrene copolymers solubility efficiency at various temperatures of application. It was found that by lowering the amount of second component, the temperature of application of the composition of the present invention should be increased in order to obtain similar polystyrene and/or styrene copolymers solubility results. It was found that compositions may be designed wherein the temperature of application may be below 0° C., even below −10° C., even about −20° C. Alternatively, compositions may be designed which may be applied at high temperatures, e.g. at a temperature of application above 30° C., of above 40° C. or even above 50° C. In order to provide such compositions, the second component may be present in the composition of the present invention in an amount of at most 20 weight-%, based on the total weight of the composition. However, the second component may also be present in an amount of at most 10 weight-%, preferably about 5 weight-%, based on the total weight of the composition.

The first component may be selected from the group consisting of organosilicon compounds, hydrocarbons, organic compounds and combinations thereof. Organosilicon compounds may include siloxane. In case the first component is a hydrocarbon, the hydrocarbon may be selected from the group consisting of aliphatic hydrocarbons including alkanes, alkenes, and naphthenes, aromatic hydrocarbons including naphthalenes and asphaltenes, and combinations thereof. Even further, the hydrocarbon is preferably selected from the group consisting of hydrocarbons having a boiling point of at least 100° C. In order to provide a composition which is environmentally safe and does not involve any health risk for the end user, the hydrocarbons used in the composition as the first component may be selected from the group consisting of hydrocarbons free of halogens. Furthermore, in order to further improve the environmental safe aspects of the composition, the second component may be selected from a group of components free of halogens. In particular, the present invention relates to a composition free of halogens.

Preferred hydrocarbons for use in the composition of the present invention may be selected from the group of hydrocarbons having a carbon content of at least C8. Preferably the hydrocarbons may be selected to have a carbon content within the range of C8 to C30, more preferably hydrocarbons having a carbon content within the range of C9 to C20 or C10 to C14.

The organosilicon compounds, hydrocarbons and organic compounds preferably selected as a first component may be linear, branched or cyclic.

The first component may also be selected from the group of organic compounds. Preferably the organic compounds for use in the composition of the present invention may include phenols, ethers, amine and combinations thereof.

With regard to the second component of the composition of the present invention, it is noted that the second component may be a solid or liquid at room temperature. The physical state of the second component at room temperature is not relevant, as long as the second component is soluble (at room temperature) in the first component as a solvent. Preferably, the second component may be selected from the group consisting of polar compounds, nonpolar compounds, heterocyclic compounds and combinations thereof. In a preferred composition of the present invention, the second component is selected from the group consisting of polar aprotic solvents.

The second component as used in the composition of the present invention may be linear, branched or cyclic. Also, it was further found that the second component may comprise O, S, N, P atoms besides C and H.

In order to further enhance the polystyrene and/or styrene copolymers solubility of the composition of the present invention, the composition may further comprise a surface active component. Such surface active component may be selected from non-ionic surfactants, anionic surfactants and combination thereof. Examples of non-ionic surfactants may include, but are not limited to, polysorbate 80 and methylcocoate. Anionic surfactants may include, but are not limited to, sodium 2-ethylhexyl sulphate, 2-ethyl hexyl-phosphate ester, ammonium bis(2-ethyl hexyl)phosphate, ethoxylated 2-ethyl hexyl-phosphate ester and ethoxylated ammonium bis(2-ethyl hexyl)phosphate ester, and combinations thereof.

In a further aspect of the present invention, the invention relates to the use of the composition of the present invention as a cleaning composition for the removal of polystyrene and/or styrene copolymers, such as acrylonitrile-butadiene styrene (ABS) resins, styrene-acrylonitrile (SAN), acrylonitrile-styrene-acrylate (ASA), styrene-butadiene (SB)-latexes, styrene-butadiene rubber (SBR) from a surface.

In an even further aspect of the present invention, the invention relates to a method for the removal of polystyrene and/or styrene copolymers, such as acrylonitrile-butadiene styrene (ABS) resins, styrene-acrylonitrile (SAN), acrylonitrile-styrene-acrylate (ASA), styrene-butadiene (SB)-latexes, styrene-butadiene rubber (SBR) from a surface, wherein the method comprises the steps of:
a) providing the composition of the present invention;
b) treating the surface comprising the polystyrene and/or styrene copolymers with the composition provided in step a).

The treatment step b) is performed by the subsequent steps:
contacting the surface with the composition provided in step a);
and
removing the composition from the surface.

Although any form of contact may be applied to the surface comprising the polystyrene and/or styrene copolymers with the composition of the present invention, in a preferred embodiment, step b) is performed by flushing the surface with the composition provided in step a). Additionally, step b) is repeated until the removal of polystyrene and/or styrene copolymers is finalized.

Given the above composition, use and method of the present invention, it was found that hard chunks of polystyrene and/or styrene copolymers can be fully dissolved at room temperature (and lower temperatures) into a pumpable mixture using the composition of the present invention.

It was further found that the composition of the present invention is able to first swell the polystyrene and/or styrene copolymer before or during dissolving the polystyrene and/or styrene copolymer.

The method of the present invention may be performed at various temperatures. In fact, any temperature between −20° C. and 100° C. may be applied during the removal of the polystyrene and/or styrene copolymer using the composition of the present invention. It is noted that the higher the temperature the faster the cleaning and dissolving of the polystyrene and/or styrene copolymer. Preferably, the method is performed under ambient conditions, i.e. between 15° C. and 25° C. However higher or lower temperatures may be applied as well.

It was further observed that the presence of water does not negatively influence the solubility properties of the composition of the present invention.

Regarding the method of the present invention, it is further noted that, after the polystyrene and/or styrene copolymer is fully dissolved, the pumpable liquid can be drained from the system and the system is air dried. After drainage of the dissolved polystyrene and/or styrene copolymer, the system may be washed and rinsed with water to remove any remaining constituents of the composition of the present invention. Subsequently, the system is preferably air dried.

After cleaning of a system using the composition of the present invention, it was noted that the Lower Explosive Limit (LEL)-value is close to zero percent.

In order to provide further guidance, the following table provide an overview of suitable combinations of first and second components for providing a composition for solubilizing polystyrene and/or styrene copolymers.

TABLE 1
First overview of combinations of subsets of first and second components

| Subset | First component | Second component |
|---|---|---|
| 1 | 1,2,3,5-Tetramethylbenzene | Cinnamyl Alcohol |
| | 1,2,3,4-Tetramethylbenzene | Eugenol |
| | Cyclohexane | 3-Methyl-1-Butanol |
| | 2,2,4-Trimethylpentane | 2-Methyl-2-Butanol |
| | Isooctane | 2-Pentanol |
| | Decane | 3-Methyl-2-Butanol |
| | Dodecane | 3,4-Dimethyl Phenol |
| | Undecane | Cyclohexanol |
| | Hexadecane | 2-Ethyl-1-Butanol |
| | Cyclododecane | 2-Methyl-1-Pentanol |
| | Eicosane | 2,2-Dimethyl-1-Propanol |
| | Bicyclohexyl | Ethylene Glycol Mono n-Propyl Ether |
| | Shellsol D60 | 3-Methoxy Butanol |
| | Shellsol D100 | Benzyl Alcohol |
| | Cis-Decahydronaphthalene | m-Cresol |
| | Hexamethyl Benzene | 2,6-Dimethoxy Phenol |
| | | 1-Pentanol |
| | | Glycerol Diacetate |
| | | 2-Methyl-1-Butanol |
| | | 2-Phenoxy Ethanol |
| | | Diethylenetriamine |
| | | 2-Butanol |
| | | t-Butyl Alcohol |
| | | Phenol |
| | | Ethylene Glycol Monomethyl Ether |
| | | 1,2,3-Triazole |
| | | 1,9-Nonanediol |
| | | 2-Cyclopentenyl Alcohol |
| | | 1-Butanol |
| | | Iso-Butanol |
| | | N-Methyl Formamide |
| | | Coniferyl Alcohol |
| | | 3-Hydroxy Tetrahydrofuran |
| | | 2-Propanol (isopropanol) |
| | | p-Coumaryl Alcohol |
| | | 1-Propanol |
| | | Glycerol Carbonate |
| | | Dipropylene Glycol |
| | | 1,2-Cyclohexanediol |
| | | 2,5-Tetrahydrofuran Dimethanol |
| | | Diethanolamine |
| | | Diethylene Glycol (DEG) |
| | | 1,3-Benzenediol |
| | | 1,3-Butanediol |
| | | 1,4-Butanediol |
| | | Pyrogallol |
| | | 1,2-Dihydroxybenzene (Catechol) |
| | | 1,3-Propanediol |
| | | Ethylene Glycol |
| | | 1,4-Dihydroxybenzene |
| 2 | Dimethyl Cyclohexane | Indene |
| | Decamethylcyclopentasiloxane | Di-(2-Ethyl Hexyl) Sebacate |
| | Methyl Cyclohexane | 2-Pyrrolidone |
| | n-Butyl Toluene | Glycerol Triacetate |
| | 1,2-Diethyl Benzene | Propylene Glycol Monobutyl Ether |
| | Trimethylbenzene | Diethylene Glycol Monoethyl Ether |
| | Cyclohexyl Benzene | Acetate |
| | Diphenylmethane | Butyl Formate |
| | | Triethyl Phosphate |
| | | N,N-Diethyl Formamide |
| | | Glycerol Carbonate Acetate |
| | | Dodecanol |
| | | Methyl Palmitate |
| | | Ethylene Glycol Mono Ethyl Ether |
| | | Acrylate |
| | | 1,2-Dimethoxybenzene |
| | | N,N-Dimethyl Acetamide |
| | | γ-crotonolactone (GCL) = 2- |
| | | Furanone |
| | | Dimethyl Carbonate |
| | | Ethylene Glycol Diacetate |
| | | Propylene Glycol Monomethyl Ether |
| | | Acetate |
| | | 2,2,4-Trimethyl-1,3-Pentanediol |
| | | Monoisobutyrate (Texanol) |
| | | Ethyl trimethylacetate |
| | | 2-Decanol |
| | | Methyl Laurate |
| | | Diethylene Glycol Hexyl Ether |
| | | Dipropylene Glycol Mono n-Butyl |
| | | Ether |
| | | Butyl Lactate |
| | | Butoxy Ethoxy Propanol |
| | | Dimethyl Sulfoxide (DMSO) |
| | | Thiophenol |
| | | Methyl Trimethyl Acetate |
| | | 2-t-Butyl-4-Methyl Phenol |
| | | 1-Decanol |
| | | Diethylene Glycol Monobutyl Ether |
| | | (Butyl Carbitol) |
| | | Di-Isobutyl Carbinol |
| | | Ethylene Glycol Mono t-Butyl Ether |
| | | Diacetone Alcohol |
| | | Thiazole |
| | | 1-Nonanol |
| | | 2-Octanol |
| | | Dipropylene Glycol Mono n-Propyl |
| | | Ether |
| | | Tetramethylurea |
| | | 1-Octanol |
| | | 2-Phenyl Ethanol |
| | | Dipropylene Glycol Methyl Ether |
| | | Dipropylene Glycol Methyl Ether |
| | | Vanillin |
| | | 1-Methyl Imidazole |
| | | p-Anisidine (Methoxy Aniline) |
| | | Diethylene Glycol Monopropyl Ether |
| | | Pyrimidine |
| | | Ethylene Glycol Mono n-Hexyl Ether |
| | | Propylene Glycol Phenyl Ether |
| | | Propylene Glycol Monomethyl Ether |
| | | 1-Heptanol |
| | | 3-Heptanol |
| | | 2-Heptanol |
| | | Pyridazine |
| | | 2-Ethyl-Hexanol |
| | | 1-Methyl Cyclohexanol |
| | | Castor Oil |
| | | 2-Ethylhexyl lactate |
| | | Crotonic Acid |
| | | Ethylene Glycol Mono Benzyl Ether |
| | | Diethylene Glycol Monoethyl Ether |
| | | Methyl Isobutyl Carbinol |
| | | Ethylene Glycol Monobutyl Ether |
| | | 1-Naphthol |
| | | Dimethyl Sulfone |
| | | Pyrazole |
| | | 1,2,3-Benzotriazole |
| | | 1-Hexanol |
| | | 4-Methyl Cyclohexanol (Mix) |
| | | 3-Methyl Cyclohexanol |
| | | 2-Methyl Cyclohexanol (Mix) |
| | | Ethyl Lactate |
| | | 4-Ethyl Phenol |
| | | Diethylene Glycol Monomethyl Ether |
| | | (Methyl Carbitol) |
| | | 2,6-Dimethyl Phenol |
| | | 3-Methoxy-3-Methyl Butanol |
| | | Tetrahydrofurfuryl Alcohol |
| 3 | Ethyl Benzene | p-Divinyl Benzene |
| | Shellsol A150 | Glycerol Tributyrate |
| | Shellsol A150 ND | Iso-Pentyl Acetate |
| | Solvesso 200 | 4-Methoxy Acetophenone |
| | Solvesso 200 ND | Cyrene (Dihydrolevoglucosenone) |
| | | Dibutyl Maleate |
| | | Diethylene Glycol Methyl t-Butyl |
| | | Ether |
| | | N-Methyl-2-Pyrrolidone (NMP) |
| | | 2,5-Diethoxy Tetrahydrofuran |
| | | 2-Methylfuran |
| | | 3-Ethoxy Propionaldehyde |
| | | Di-Isopropyl Sulfoxide |
| | | Crotonaldehyde |
| | | Caprolactone (Epsilon) |
| | | γ-Butyrolactone (GBL) |
| | | Diethyl Adipate |
| | | N,N′-Dimethylimidazolidinone (DMI) |
| | | Ethyl Methacrylate |
| | | N,N-Diethyl Acetamide |
| | | sec-Butyl Acetate |
| | | n-Propyl Acetate |
| | | 3-Methyl-3-Methoxy Butyl Acetate |
| | | Propylene Glycol Monoethyl Ether |
| | | Acetate |
| | | 1,4-Thioxane |
| | | 2-Methoxy-1,3-Dioxolane |
| | | Diethyl Glutarate |
| | | 3-Methoxypropionitrile |
| | | Diketene |
| | | Methyl Phenyl Sulfone |
| | | Diethylene Glycol Divinyl Ether |
| | | Dipropylene Glycol Monomethyl |
| | | Ether Acetate |
| | | Tetrahydrofuran (THF) |
| | | 1,2-Cyclohexanedione |
| | | Cetyl Alcohol (1-Hexadecanol) |
| | | 3-Methoxy Butyl Acetate |
| | | Butyl Diglycol Acetate |
| | | Ethylene Glycol Di-t-Butyl Ether |
| | | Isopropyl Acetate |
| | | Ethylene Glycol Methyl t-Butyl Ether |
| | | 2,5-Dimethoxytetrahydrofuran |
| | | 1-Acetoxy-1,3-Butadiene |
| | | Diethyl Malonate |
| | | Anisaldehyde |
| | | Di-(2-Ethylhexyl)Azelate |
| | | Dibasic Esters (DBE) |
| | | Dimethyl Adipate |
| | | Diethyl Succinate |
| | | Hexamethylphosphoramide |
| | | Sulfolane (Tetramethylene Sulfone) |
| | | Glycerol Carbonate Ethyl Ether |
| | | Ethyl 3-Ethoxypropionate |
| | | Diethyl Oxalate |
| | | Benzisoxazole |
| 4 | 1-Nonene | Ethylene Glycol 2-Ethylhexyl Ether |
| | 1-Decene | Butyl Isopropenyl Ether |
| | Shellsol A100 | Isophorone |
| | Toluene | Dimethyl 2-Methylglutarate |
| | Biphenyl | Nitroethylene |
| | 1-Tetradecene | Benzophenone |
| | Cycloheptane | Cyclohexanone |
| | Naphtha (high-flash) | Methyl Ethyl Ketone (MEK) |
| | | Ethylene Carbonate |
| | | Dibenzyl Ether |
| | | Benzyl Benzoate |
| | | Ethylene Glycol Diethyl Ether |
| | | 1,3-Dimethoxy Butane |
| | | d-Camphor |
| | | Cyclobutanone |
| | | Cyclopentanone |
| | | Furan |
| | | Benzaldehyde |
| | | Methyl Sulfolane |
| | | 1-Methoxy-1,3-Butadiene |
| | | 4-Methoxy Benzonitrile |
| | | Dibenzyl Sebacate |
| | | Butyl Benzoate |
| | | 1-Nitropropane |
| | | 1-Methoxy-2-Nitrobenzene |
| | | 1,3-Butadiene |
| | | 1-Methyl Vinyl Methyl Ether |
| | | Isoamyl Propionate |
| | | Diethylene Glycol Diethyl Ether |
| | | 2,3-Benzofuran (Cumaron) |
| | | Quinoline |
| | | n-Propyl Propanoate |
| | | Isobutyl Isobutyrate |
| | | Naphthalene |
| | | n-Butyl Propionate |
| | | 1,2-Methylenedioxybenzene |
| | | Pyridine |
| | | t-Butyl Acetate |
| | | Anethole (Trans) |
| | | Benzyl Acetate |
| | | Ethylene Glycol Dimethyl Ether |
| | | 2-Methoxy Tetrahydropyrane |
| | | Amyl Acetate |
| | | n-Amyl Acetate |
| | | Di-Isobutyl Sulfoxide |
| | | Acetonitrile |
| | | Diisobutyl Adipate |
| | | N,N-Dibutyl Formamide |
| | | Trans-Cinnamaldehyde |
| | | n-Butyl Acetate |
| | | Isobutyl Acetate |
| | | 4-Ethoxy Acetophenone |
| | | Cyclohexylamine |
| | | Di-(2-Methoxyethyl) Ether |
| | | Indole |
| | | 4-Ethyl Morpholine |
| | | Di Butyl Fumarate |
| | | Coumarin |
| | | 1,1,3,3-Tetramethoxypropane |
| | | Ethylene Glycol Butyl Ether Acetate |
| | | 2,5-Dimethyl Pyrrole |
| | | 2-Methylanisole |
| | | Anisole |
| 5 | 1-Heptene | Phenyl Acetylene |
| | Di-2-Ethylhexyl Ether | 1,1-Diethoxy Ethane |
| | p-Cymene | Acetophenone |
| | 1-Octene | Di-Isobutyl Ketone |
| | a-Methyl Styrene | Dibutyl Sebacate |
| | | Ethyl Amyl Ketone |
| | | Methyl Isoamyl Ketone |
| | | Methyl Isobutyl Ketone (MIBK) |
| | | Cyclodecanone |
| | | Ethyl Cinnamate |
| | | Dibutyl Phthalate |
| | | 2,4-Pentanedione |
| | | Propylene Carbonate |
| | | 1,9-Decadiene |
| | | Butyl Oleate |
| | | Ethylene Glycol Dibutyl Ether |
| | | 1,4-Butandiol Diacrylate |
| | | d-Limonene |
| | | Dibutyl Amine |
| | | Cyclopentyl Methyl Ether (Cpme) |
| | | 2-Methyl Tetrahydrofuran |
| | | Diethylene Glycol Dibutyl Ether |
| | | Dibutyl Ketone |
| | | FAME (fatty acid methyl ester) |
| | | Methyl Oleate |
| | | Diethyl Phthalate |
| | | Cyclooctanone |
| | | Tricresyl Phosphate |
| | | 1,1-Diethoxy Butane |
| | | Ethylene Glycol Butyl Ethyl Ether |
| | | Cyclopropylmethylketone |
| | | 1-Methyl Naphthalene |
| | | Methyl Propyl Ketone |
| | | 3-Methyl Cyclohexanone |
| | | 2-Methyl Cyclohexanone |
| | | Cycloheptanone |
| | | Valeronitrile |
| | | Di-Isononyl Adipate |
| | | 1,1-Dimethoxy Ethane |
| | | Ethylene Glycol Butyl Methyl Ether |
| | | Dimethyl Phthalate |
| 6 | 2-Ethyl-1-Butene | a-Methyl Styrene |
| | Di-2-Ethylhexyl Amine | Di-2-Ethylhexyl Ether |
| | Camphene | Di-Isodecyl Phthalate |
| | Xylene | Dihexyl Ether |
| | 1-Hexene | Tetralin (Tetrahydronaphthalene) |
| | Tetralin (Tetrahydronaphthalene) | Di-Isononyl Phthalate |
| | | Butylene carbonate |
| | | Xylene |
| | | 2-Pinene (dl) |
| | | Camphene |
| | | Diethylhexyl Phthalate |
| | | Benzyl Butyl Phthalate |
| | | Di p-Tolyl Sulfoxide |
| | | 2,3-Butylene Carbonate |
| | | Di-2-Ethylhexyl Amine |
| | | Benzonitrile |
| | | 1,8-Cineole (Eucalyptol) |
| | | Di-Isoheptyl Phthalate |
| | | Diphenyl Sulfone |
| | | 2-Ethyl-1-Butene |
| | | Butyl Stearate |
| | | Diethyl Carbonate |
| | | Dihexyl Phthalate |
| | | p-Nitro Toluene |
| | | Linseed oil |
| | | 2-Vinyl Toluene |
| | | Benzyl Ethyl Ether |
| | | Methyl-p-Toluate |
| | | 1,5-Hexadiene |
| 7 | Cis-Cyclooctene | Butylhydroxytolueen |

TABLE 2
Second overview of combinations of subsets of first and second components

| Subset | First component | Second component |
|---|---|---|
| 8 | Dimethyl Cyclohexane | Benzonitrile |
| | Methyl Cyclohexane | 2-Pyrrolidone |
| | Cyclohexyl Benzene | Diethylene Glycol (DEG) |
| | Cyclohexane | Tricresyl Phosphate |
| | 2,2,4-Trimethylpentane | 1-Nitropropane |
| | Isooctane | N-Methyl-2-Pyrrolidone (NMP) |
| | Decane | Trans-Cinnamaldehyde |
| | Dodecane | Cyrene (Dihydrolevoglucosenone) |
| | Undecane | Coumarin |
| | Hexadecane | 1-Methoxy-2-Nitrobenzene |
| | Cyclododecane | 1,3-Propanediol |
| | Eicosane | Diphenyl Sulfone |
| | Bicyclohexyl | 3-Methoxypropionitrile |
| | Cis-Decahydronaphthalene | Diketene |
| | Shellsol D60 | Glycerol Carbonate Acetate |
| | Shellsol A100 | Crotonaldehyde |
| | Shellsol D100 | Caprolactone (Epsilon) |
| | n-Butyl Toluene | 1-Methyl Imidazole |
| | 1,2-Diethyl Benzene | 1,2,3-Benzotriazole |
| | | Dimethyl Sulfoxide (DMSO) |
| | | Nitroethylene |
| | | γ-Butyrolactone (GBL) |
| | | 4-Methoxy Benzonitrile |
| | | 2,3-Butylene Carbonate |
| | | Methyl Phenyl Sulfone |
| | | Methyl Sulfolane |
| | | Sulfolane (Tetramethylene Sulfone) |
| | | Pyridazine |
| | | Propylene Carbonate |
| | | Acetonitrile |
| | | Glycerol Carbonate Ethyl Ether |
| | | Thiazole |
| | | N-Methyl Formamide |
| | | Dimethyl Sulfone |
| | | γ-crotonolactone (GCL) |
| | | Ethylene Carbonate |
| | | Glycerol Carbonate |
| 9 | 1-Tetradecene | Acetophenone |
| | 1,2,3,5-Tetramethylbenzene | 2,4-Pentanedione |
| | 1,2,3,4-Tetramethylbenzene | Methyl Ethyl Ketone (MEK) |
| | Ethyl Benzene | 1,4-Butandiol Diacrylate |
| | Shellsol A150 | Diethylene Glycol Monoethyl Ether |
| | Shellsol A150 ND | (ethylene diglycol) |
| | Solvesso 200 | Pyrimidine |
| | Solvesso 200 ND | 3-Hydroxy Tetrahydrofuran |
| | Cis-Cyclooctene | Diethyl Phthalate |
| | Naphtha (high-flash) | Cyclooctanone |
| | | Butylene carbonate |
| | | Vanillin |
| | | 1,2-Cyclohexanediol |
| | | 1,4-Dihydroxybenzene |
| | | d-Camphor |
| | | 4-Ethoxy Acetophenone |
| | | 1,2-Cyclohexanedione |
| | | Pyrazole |
| | | Di-Isobutyl Sulfoxide |
| | | Cycloheptanone |
| | | Dipropylene Glycol |
| | | 1,2,3-Trihydroxybenzene |
| | | Dimethyl Phthalate |
| | | p-Nitro Toluene |
| | | Valeronitrile |
| | | 1,4-Butanediol |
| | | Ethylene Glycol |
| | | Cyclopropylmethylketone |
| | | Benzyl Butyl Phthalate |
| | | 4-Methoxy Acetophenone |
| | | N,N-Diethyl Acetamide |
| | | 1,2-Dihydroxybenzene (Catechol) |
| | | Di p-Tolyl Sulfoxide |
| | | Cyclobutanone |
| | | Triethyl Phosphate |
| | | N,N-Diethyl Formamide |
| | | Di-Isopropyl Sulfoxide |
| | | Benzisoxazole |
| | | N,N-Dimethyl Acetamide |
| | | Hexamethylphosphoramide |
| | | Cyclopentanone |
| | | Anisaldehyde |
| 10 | Di-2-Ethylhexyl Amine | Diethylhexyl Phthalate |
| | Xylene | Diethyl Glutarate |
| | 1-Octene | Diethylene Glycol Monobutyl Ether |
| | 1-Nonene | 1,9-Nonanediol |
| | 1-Decene | Coniferyl Alcohol |
| | Biphenyl | p-Coumaryl Alcohol |
| | Trimethylbenzene | Diethanolamine |
| | Diphenylmethane | 1,1,3,3-Tetramethoxypropane |
| | 1-Hexene | N,N′-Dimethylimidazolidinone (DMI) |
| | 1-Heptene | Diethylenetriamine |
| | | Di-Isoheptyl Phthalate |
| | | Benzophenone |
| | | Diethylene Glycol Methyl t-Butyl |
| | | Ether |
| | | Ethyl Methacrylate |
| | | 2,5-Dimethoxytetrahydrofuran |
| | | Diethylene Glycol Monopropyl Ether |
| | | Diethylene Glycol Divinyl Ether |
| | | Benzaldehyde |
| | | Indole |
| | | Ethylene Glycol Butyl Ether Acetate |
| | | Eugenol |
| | | Dihexyl Phthalate |
| | | Methyl Propyl Ketone |
| | | 2,5-Dimethyl Pyrrole |
| | | Ethyl trimethylacetate |
| | | Ethyl Lactate |
| | | 2,6-Dimethoxy Phenol |
| | | 2-Cyclopentenyl Alcohol |
| | | Dibutyl Ketone |
| | | 3-Methyl Cyclohexanone |
| | | Diethyl Malonate |
| | | 2-Methyl Cyclohexanone |
| | | Diethylene Glycol Monomethyl Ether |
| | | Cyclodecanone |
| | | Isophorone |
| | | Diethyl Oxalate |
| | | Methyl Trimethyl Acetate |
| | | 1,3-Benzenediol |
| | | 1,3-Butanediol |
| | | Ethyl Cinnamate |
| | | Diacetone Alcohol |
| | | Tetramethylurea |
| | | Tetrahydrofurfuryl Alcohol |
| | | Ethylene Glycol Monomethyl Ether |
| | | 1-Methoxy-1,3-Butadiene |
| | | Cyclohexanone |
| | | 2-Methoxy-1,3-Dioxolane |
| | | 2,5-Tetrahydrofuran Dimethanol |
| | | Dibutyl Phthalate |
| | | Dimethyl Carbonate |
| | | Dimethyl 2-Methylglutarate |
| | | Crotonic Acid |
| | | Ethylene Glycol Mono n-Propyl Ether |
| | | Pyridine |
| | | 3-Ethoxy Propionaldehyde |
| | | 1,2,3-Triazole |
| | | N,N-Dibutyl Formamide |
| | | Glycerol Diacetate |
| 11 | Decamethylcyclopentasiloxane | 2-Methyl Tetrahydrofuran |
| | Toluene | 4-Ethyl Morpholine |
| | Cycloheptane | Di-(2-Ethyl Hexyl) Sebacate |
| | Hexamethyl Benzene | Methyl Laurate |
| | 2-Ethyl-1-Butene | 1-Octanol |
| | Camphene | Ethylene Glycol Mono n-Hexyl Ether |
| | | Benzyl Benzoate |
| | | 2,3-Benzofuran (Cumaron) |
| | | Ethylene Glycol Methyl t-Butyl Ether |
| | | Diethylene Glycol Monoethyl Ether |
| | | Acetate |
| | | Ethylene Glycol Mono Ethyl Ether |
| | | Acrylate |
| | | Ethylene Glycol Monobutyl Ether |
| | | 2-Methyl-1-Butanol |
| | | t-Butyl Alcohol |
| | | Ethylene Glycol Butyl Methyl Ether |
| | | Isoamyl Propionate |
| | | 4-Ethyl Phenol |
| | | 3-Methyl-1-Butanol |
| | | 3-Methyl-2-Butanol |
| | | Butyl Isopropenyl Ether |
| | | Propylene Glycol Phenyl Ether |
| | | 1-Heptanol |
| | | Ethylene Glycol Diethyl Ether |
| | | 3-Heptanol |
| | | 2-Heptanol |
| | | 3-Methoxy Butanol |
| | | 1,3-Dimethoxy Butane |
| | | n-Butyl Propionate |
| | | Butyl Benzoate |
| | | Quinoline |
| | | n-Propyl Propanoate |
| | | Propylene Glycol Monomethyl Ether |
| | | Acetate |
| | | 2-Phenyl Ethanol |
| | | Methyl Isoamyl Ketone |
| | | Benzyl Acetate |
| | | Tetrahydrofuran (THF) |
| | | Dipropylene Glycol Methyl Ether |
| | | Dipropylene Glycol Methyl Ether |
| | | 2-Phenoxy Ethanol |
| | | 2-Butanol |
| | | 1-Butanol |
| | | Iso-Butanol |
| | | 1-Hexanol |
| | | Diethylene Glycol Diethyl Ether |
| | | Ethylene Glycol Mono Benzyl Ether |
| | | 1-Pentanol |
| | | Phenol |
| | | Diethylene Glycol Hexyl Ether |
| | | Cinnamyl Alcohol |
| | | 3,4-Dimethyl Phenol |
| | | Methyl Isobutyl Ketone (MIBK) |
| | | Di-(2-Methoxyethyl) Ether |
| | | Dibutyl Maleate |
| | | 2,2,4-Trimethyl-1,3-Pentanediol |
| | | Monoisobutyrate (Texanol) |
| | | Ethylene Glycol Mono t-Butyl Ether |
| | | Dipropylene Glycol Mono n-Propyl |
| | | Ether |
| | | 2-Ethylhexyl lactate |
| | | 2-Methyl-2-Butanol |
| | | 2-Propanol (isopropanol) |
| | | Di-Isodecyl Phthalate |
| | | Diethyl Adipate |
| | | Diethyl Carbonate |
| | | Ethylene Glycol Dimethyl Ether |
| | | Propylene Glycol Monoethyl Ether |
| | | Acetate |
| | | Propylene Glycol Monomethyl Ether |
| | | 1-Naphthol |
| | | 4-Methyl Cyclohexanol |
| | | 3-Methoxy-3-Methyl Butanol |
| | | Benzyl Alcohol |
| | | 2,5-Diethoxy Tetrahydrofuran |
| | | 3-Methyl Cyclohexanol |
| | | 2-Pentanol |
| | | Methyl-p-Toluate |
| | | Dibasic Esters (DBE) |
| | | Butyl Formate |
| | | Dipropylene Glycol Mono n-Butyl |
| | | Ether |
| | | Butyl Lactate |
| | | Butoxy Ethoxy Propanol |
| | | p-Anisidine |
| | | 2-Methyl Cyclohexanol |
| | | 2,2-Dimethyl-1-Propanol |
| | | m-Cresol |
| | | Di-Isononyl Phthalate |
| | | 2-Methoxy Tetrahydropyrane |
| | | 1,4-Thioxane |
| | | 1,2-Methylenedioxybenzene |
| | | Dimethyl Adipate |
| | | Diethyl Succinate |
| | | 1-Propanol |
| 12 | Camphene | Di-2-Ethylhexyl Amine |
| | Tetralin (Tetrahydronaphthalene) | 1-Methyl Naphthalene |
| | Butylhydroxytolueen, 2,6-di-tert- | Xylene |
| | butyl-4-methylfenol (BHT) | 2-Vinyl Toluene |
| | p-Cymene | p-Divinyl Benzene |
| | a-Methyl Styrene | 1,9-Decadiene |
| | Di-2-Ethylhexyl Ether | 2-Ethyl-1-Butene |
| | | 2-Pinene (dl) |
| | | Camphene |
| | | d-Limonene |
| | | Di-Isononyl Adipate |
| | | Furan |
| | | Tetralin (Tetrahydronaphthalene) |
| | | Naphthalene |
| | | Butylhydroxytolueen |
| | | Dibenzyl Sebacate |
| | | a-Methyl Styrene |
| | | Diisobutyl Adipate |
| | | Glycerol Tributyrate |
| | | Di-2-Ethylhexyl Ether |
| | | FAME (fatty acid methyl ester) |
| | | Indene |
| | | Phenyl Acetylene |
| | | 1,3-Butadiene |
| | | Isobutyl Isobutyrate |
| | | 2-Methylfuran |
| | | Dihexyl Ether |
| | | Dibutyl Amine |
| | | Di Butyl Fumarate |
| | | Cyclohexylamine |
| | | Iso-Pentyl Acetate |
| | | Di-Isobutyl Carbinol |
| | | Amyl Acetate |
| | | n-Amyl Acetate |
| | | Ethyl 3-Ethoxypropionate |
| | | 2-Ethyl-Hexanol |
| | | Methyl Isobutyl Carbinol |
| | | 1,1-Diethoxy Ethane |
| | | Dibenzyl Ether |
| | | Linseed oil |
| | | Butyl Stearate |
| | | Di-Isobutyl Ketone |
| | | Butyl Oleate |
| | | t-Butyl Acetate |
| | | n-Butyl Acetate |
| | | Isobutyl Acetate |
| | | sec-Butyl Acetate |
| | | Cetyl Alcohol (1-Hexadecanol) |
| | | 2-t-Butyl-4-Methyl Phenol |
| | | Benzyl Ethyl Ether |
| | | 1,5-Hexadiene |
| | | Methyl Oleate |
| | | 3-Methyl-3-Methoxy Butyl Acetate |
| | | 2-Decanol |
| | | Ethylene Glycol 2-Ethylhexyl Ether |
| | | Dodecanol |
| | | 1-Methyl Cyclohexanol |
| | | 3-Methoxy Butyl Acetate |
| | | Diethylene Glycol Butyl Ether |
| | | Acetate (Butyl Diglycol Acetate) |
| | | Ethylene Glycol Di-t-Butyl Ether |
| | | Cyclohexanol |
| | | 1-Methyl Vinyl Methyl Ether |
| | | Cyclopentyl Methyl Ether (Cpme) |
| | | Anethole (Trans) |
| | | n-Propyl Acetate |
| | | 2-Ethyl-1-Butanol |
| | | 2-Methylanisole |
| | | Anisole |
| | | 1-Acetoxy-1,3-Butadiene |
| | | 1,2-Dimethoxybenzene |
| | | Dibutyl Sebacate |
| | | Ethyl Amyl Ketone |
| | | Ethylene Glycol Dibutyl Ether |
| | | Isopropyl Acetate |
| | | Glycerol Triacetate |
| | | Propylene Glycol Monobutyl Ether |
| | | Thiophenol |
| | | 1,8-Cineole (Eucalyptol) |
| | | Castor Oil |
| | | Diethylene Glycol Dibutyl Ether |
| | | Di-(2-Ethylhexyl)Azelate |
| | | Ethylene Glycol Diacetate |
| | | 1-Decanol |
| | | 1-Nonanol |
| | | 1,1-Diethoxy Butane |
| | | Ethylene Glycol Butyl Ethyl Ether |
| | | 1,1-Dimethoxy Ethane |
| | | Dipropylene Glycol Monomethyl |
| | | Ether Acetate |
| | | Methyl Palmitate |
| | | 2-Octanol |
| | | 2,6-Dimethyl Phenol |
| | | 2-Methyl-1-Pentanol |

### EXAMPLES

In order to determine the solubility of polystyrene in a specific solvent a swelling test was performed. In the swelling test a 5 gram polystyrene sample in a capped vial was statically held with 95 gram of the solvent at room temperature and monitored. After 3 days, the swelling and solubility of the polystyrene was determined.

For each solvent used in the swelling test, the HSP of the solvent was determined. The swelling tests performed are referred herein as “Polystyrene Solubility Test”, hereinafter referred to as “PST”.

### Polystyrene Solubility Tests 1-5

In each test vial a chunk of polystyrene was added (5 gram). To the test vials either 95 gram of toluene (PST 1) or a mixture containing Solvesso™ 150 (ExxonMobil, aromatic fluid) and a further component (PSTs 2-5; see also: table 3) was added. Therefore providing a ratio of solvent:polystyrene of 19:1. It is noted that the percentages provided in table 3 relates to the m/m-%, i.e. the mass of the component based on the total mass of the solvent. As it can be derived from table 3, compared to the reference PST 1 (toluene), an improved swelling and solubility of polystyrene was observed for PSTs 2, 3, 4 and 5.

TABLE 3
Polystyrene solubility tests 1-5

| PST | 1 | 2 | 3 | 4 | 5 |
|---|---|---|---|---|---|
| Toluene | 100% | − | − | − | − |
| Solvesso ™ 150 | − | 80% | 85% | 88% | 92% |
| Cyclohexanone | − | 20% | − | − | − |
| Diethyl phthalate | − | − | 15% | − | − |
| Dihydrolevoglucosenone | − | − | − | 12% | − |
| Propylene Carbonate | − | − | − | − | 8% |
| HSP; δD | 18.0 | 17.8 | 17.8 | 18.0 | 18.0 |
| HSP; δP | 1.4 | 2.2 | 2.0 | 2.0 | 2.0 |
| HSP; δH | 2.0 | 2.1 | 1.9 | 1.6 | 1.6 |
| Solubility^{a} | +/− | + | + | + | + |

^{a}after 3 days, the solubility of the polystyrene was observed and classified using the following categories: (−) no changes to the polymer, (+/−) polymer dissolves partly, and (+) polymer dissolves fully.

### Polystyrene Solubility Test 6

Comparable to PST 5, 95% (m/m) Solvesso™ 150 and 5% (m/m) propylene carbonate were mixed. To this mixture a hard chunk of polystyrene was added with a ratio of mixture: hard polystyrene of 19:1. Compared to PST 1 (toluene) an improved swelling and solubility of polystyrene was observed, similar to the results obtained for PST 5.

### Polystyrene Solubility Test 7

Comparable to PST 6, 95% (m/m) Solvesso™ 150 and 5% (m/m) propylene carbonate were mixed. To this mixture a soft piece of polystyrene was added with a ratio of mixture:soft piece of polystyrene of 19:1. Compared to PST 1 (toluene) an improved swelling and solubility of polystyrene was observed, similar to the results obtained for PST 5 and PST 6.

### Polystyrene Solubility Test 8

At industrial scale, pipelines, reactors, heat exchangers, tanks or any possible unit operation, which may contain polystyrene deposits are first wetted with mixtures as described in PSTs 2-7. Such wetting of polystyrene deposits containing equipment is typically performed at temperatures <60° C. due to safety reasons. Given the fact that the polystyrene deposits containing equipment is first wetted before any further polystyrene cleaner is used in order to remove the polystyrene deposits from the equipement to be clean, the impact of water on the solubility of polystyrene was investigated for the solutions provided in PSTs 2-7. Therefore, comparable to PST 5, 95% (m/m) Solvesso™ 150 and 5% (m/m) propylene carbonate were mixed. To this mixture water was added to obtain two phases. Then, a hard chunk of polystyrene was added with a ratio of mixture:hard polystyrene:water of 19:1:2. Compared to PST 6 the same swelling and solubility of polystyrene was observed.

In addition to the PSTs performed above, it was investigated whether or not surface active components may be present in the solutions provided by the present invention. In order to investigate the effect of an surface active component, a third component was added to the solutions. The results are provided below in PSTs 9-15.

### Polystyrene Solubility Test 9

47.5 g of Solvesso™ 150 was added in a vial. Subsequently, 2.5 g of propylene carbonate was added to obtain a clear mixture. To this mixture 0.5 g sodium 2-ethylhexyl sulfate (40% in water) was added to obtain two phases. It was observed that the top phase was an emulsion and bottom phase was clear. The ratio of Solvesso™ 150:propylene carbonate: 2-ethylhexyl sulfate (40% in water) was 95:5:1. Then, 2.5 g of polystyrene was added to the vial and the mixture was stirred with a magnetic stirrer at room temperature. After 3 days it was observed that the polystyrene was fully dissolved and an emulsion was obtained. The emulsion was a pumpable liquid.

### Polystyrene Solubility Test 10

47.5 g of Solvesso™ 150 was added in a vial. Subsequently, 2.5 g of propylene carbonate was added to obtain a clear mixture. To this mixture 0.5 g 2-ethyl hexyl-phosphate ester was added to obtain one single and clear phase. The ratio of Solvesso™ 150:propylene carbonate: 2-ethyl hexyl-phosphate ester was 95:5:1. Then, 2.5 g of polystyrene was added to the vial and the mixture was stirred with a magnetic stirrer at room temperature. After 3 days it was observed that the polystyrene was fully dissolved and a clear and pumpable liquid was obtained.

### Polystyrene Solubility Test 11

47.5 g of Solvesso™ 150 was added in a vial. Subsequently, 2.5 g of propylene carbonate was added to obtain a clear mixture. To this mixture 0.5 g ammonium bis(2-ethyl hexyl)phosphate was added to obtain an emulsion. The ratio of Solvesso™ 150:propylene carbonate:ammonium bis(2-ethyl hexyl)phosphate was 95:5:1. Then, 2.5 g of polystyrene was added to the vial and the mixture was stirred with a magnetic stirrer at room temperature. After 3 days it was observed that the polystyrene was fully dissolved and a pumpable emulsion was obtained.

### Polystyrene Solubility Test 12

47.5 g of Solvesso™ 150 was added in a vial. Subsequently, 2.5 g of propylene carbonate was added to obtain a clear mixture. To this mixture 0.5 g ethoxylated (>3 EO) 2-ethyl hexyl-phosphate ester was added to obtain a clear solution. The ratio of Solvesso™ 150:propylene carbonate:ethoxylated (>3 EO) 2-ethyl hexyl-phosphate ester was 95:5:1. Then, 2.5 g of polystyrene was added to the vial and the mixture was stirred with a magnetic stirrer at room temperature. After 3 days it was observed that the polystyrene was fully dissolved and a pumpable liquid was obtained.

### Polystyrene Solubility Test 13

47.5 g of Solvesso™ 150 was added in a vial. Subsequently, 2.5 g of propylene carbonate was added to obtain a clear mixture. To this mixture 0.5 g ethoxylated (>3 EO) ammonium bis(2-ethyl hexyl)phosphate ester was added to obtain an emulsion. The ratio of Solvesso™ 150:propylene carbonate:ethoxylated (>3 EO) ammonium bis(2-ethyl hexyl)phosphate ester was 95:5:1. Then, 2.5 g of polystyrene was added to the vial and the mixture was stirred with a magnetic stirrer at room temperature. After 3 days it was observed that the polystyrene was fully dissolved and a pumpable emulsion was obtained.

### Polystyrene Solubility Test 14

47.5 g of Solvesso™ 150 was added in a vial. Subsequently, 2.5 g of propylene carbonate was added to obtain a clear mixture. To this mixture 0.5 g dispersant with methylcocoate was added to obtain a clear solution. The ratio of Solvesso™ 150:propylene carbonate:methylcocoate was 95:5:1. Then, 2.5 g of polystyrene was added to the vial and the mixture was stirred with a magnetic stirrer at room temperature. After 3 days it was observed that the polystyrene was fully dissolved and a pumpable liquid was obtained.

### Polystyrene Solubility Test 15

47.5 g of Solvesso™ 150 was added in a vial. Subsequently, 2.5 g of propylene carbonate was added to obtain a clear mixture. To this mixture 0.5 g polysorbate 80 was added to obtain an emulsion. The ratio of Solvesso™ 150: propylene carbonate:polysorbate 80 was 95:5:1. Then, 2.5 g of polystyrene was added to the vial and the mixture was stirred with a magnetic stirrer at room temperature. After 3 days it was observed that the polystyrene was fully dissolved and a pumpable emulsion was obtained.

### Polystyrene Solubility Test 16

In order to investigate the impact of water on the solubility of polystyrene (in further combination with the surface active component), comparable to PSTs 9-15 the polystyrene cleaning was performed, however this time water was added after the addition of the surface active component (hereinafter referred to as “third component”), i.e. 47.5 g of Solvesso™ 150 was added in a vial. Subsequently, 2.5 g of propylene carbonate was added to obtain a clear mixture. To this mixture 0.5 g of a third component, as used in PSTs 9-15, and then 5 g water was added. The ratio of Solvesso™ 150:propylene carbonate:third component:water was 95:5:1:10. Then, 2.5 g of polystyrene was added to the vial and the mixture was stirred with a magnetic stirrer at room temperature. After 3 days it was observed that the polystyrene was fully dissolved and a pumpable two phase system was obtained with water as the bottom phase and polystyrene dissolved in the top phase.

### Polystyrene Solubility Tests 17-22

In order to investigate the cleaning properties of different mixtures of hydrocarbon as well as the influence of the third component, comparable to PST 16 the solubility of polystyrene for several mixtures were tested. An overview of the mixtures is provided in table 4. In general, 47.5 g of hydrocarbon mixture was added in a vial. Subsequently, 2.5 g of propylene carbonate was added to obtain a clear mixture. To this mixture 0.5 g of a third component (see: table 4) and then 5 g water was added. The ratio of hydrocarbon mixture:propylene carbonate:third component:water 95:5:1:10. Then, 2.5 g of polystyrene was added to the vial and the mixture was stirred with a magnetic stirrer at room temperature. As a comparative example, PST 16 (derived from PST 9) has been included in table 4.

TABLE 4
Polystyrene solubility tests 16-22

| | Hydrocarbon | | Third | Top | Bottom |
|---|---|---|---|---|---|
| PST | mixture | Ratio | component | phase | phase |
| 16 | Solvesso ™ 150 | 100 | Sodium 2-ethylhexyl | white | clear |
| | | | sulfate (40% in water) | emulsion | |
| 17 | ShellSol ™ D60 | 20 | 2-Ethyl hexyl-phosphate | yellow | clear |
| | Solvesso ™ 200 | 75 | ester | emulsion | |
| 18 | HF-1000 | 20 | Ammonium bis(2-ethyl | white | clear |
| | ShellSol ™ 100 | 75 | hexyl)phosphate | emulsion | |
| 19 | Parafol 1014 | 20 | Ethoxylated (>3 EO) 2- | white | clear |
| | ShellSol ™ 150 | 75 | ethyl hexyl-phosphate | emulsion | |
| | | | ester | | |
| 20 | Diesel | 10 | Ethoxylated (>3 EO) | white | clear |
| | Solvesso ™ 150 | 85 | ammonium bis(2-ethyl | emulsion | |
| | | | hexyl)phosphate ester | | |
| 21 | ShellSol ™ D60 | 10 | Methylcocoate | white | clear |
| | HF-1000 | 10 | | emulsion | |
| | Solvesso ™ 150 | 75 | | | |
| 22 | Shellsol ™ D60 | 10 | Polysorbate 80 | yellow | clear |
| | HF-1000 | 10 | | emulsion | |
| | Solvesso ™ 150 | 25 | | | |
| | ShellSol ™ 100 | 25 | | | |
| | ShellSol ™ 200 | 25 | | | |

After 3 days polystyrene was observed and it was noted that in each of the PSTs the polystyrene was fully dissolved and a pumpable two phase system was obtained with water as the bottom phase and polystyrene dissolved in the top phase. The vials were drained and left to air to dry. After drying of the vials no solid polystyrene was visible, i.e. confirming the observed result that all polystyrene was solubilized.

1. A composition for solubilizing polystyrene, comprising a first component and a second component, wherein the first component is selected from the group consisting of solvents having a flashpoint of at least 25° C.; and wherein the second component is soluble in the first component,
wherein the second component is selected such that the composition having a solubility parameter expressed in Hansen solubility parameters (HSP) where:
δD is about 17.25 MPa^{1/2} to about 18.25 MPa^{1/2};
δP is about 1.0 MPa^{1/2} to about 2.5 MPa^{1/2}; and
δH is about 1.0 MPa^{1/2} to about 2.5 MPa^{1/2}.

2. The composition according to claim 1, wherein the second component is selected such that the composition having a solubility parameter expressed in Hansen solubility parameters (HSP) where:
δD is about 17.5 MPa^{1/2} to about 18.1 MPa^{1/2};
δP is about 1.4 MPa^{1/2} to about 2.2 MPa^{1/2}; and
δH is about 1.4 MPa^{1/2} to about 2.2 MPa^{1/2}.

3. The composition according to claim 1, wherein the first component is selected from the group consisting of solvents having:
a δP and/or δH of less than 5.0 MPa^{1/2};
a δP of less than 3.0 MPa^{1/2};
a δH of less than 5.0 MPa^{1/2}; and/or
a δD in the range of 12.5 MPa^{1/2} to 20.0 MPa^{1/2}.

4. The composition according to claim 1, wherein the second component having:
a δP of at least 1.0 MPa^{1/2};
a δH of at least 2.5 MPa^{1/2}; and/or
a δD in the range of 13.5 MPa^{1/2} to 21.5 MPa^{1/2}.

5. The composition according to claim 1, wherein the first component is present in an amount of at least 80 weight-% based on the total weight of the composition and/or wherein the second component is present in an amount of at most 20 weight % based on the total weight of the composition.

6. The composition according to claim 1, wherein the first component is selected from the group consisting of:
hydrocarbons having a boiling point of at least 100° C.;
hydrocarbons free of halogens; and/or
organosilicon compounds, hydrocarbons, organic compounds and combinations thereof.

7. The composition according to claim 6, wherein the hydrocarbons are selected from the group consisting of:
aliphatic hydrocarbons including alkanes, alkenes, and naphthenes, aromatic hydrocarbons including naphthalenes and asphaltenes, and combinations thereof; and/or
hydrocarbons having a carbon content within the range of C8 to C30.

8. The composition according to claim 6, wherein the organosilicon compounds, hydrocarbons and organic compounds are linear, branched or cyclic.

9. The composition according to claim 6, wherein the organic compounds are selected from phenols, ethers, amine and combinations thereof.

10. The composition according to claim 1, wherein the second component is selected from the group consisting of polar compounds, nonpolar compounds, heterocyclic compounds and combinations thereof.

11. The composition according to claim 1, wherein the second component is linear, branched or cyclic; and/or wherein the second component comprises O, S, N and/or P atoms.

12. The composition according to claim 1, wherein the composition further comprises a surface active component, preferably selected from non-ionic surfactants, such as polysorbate 80 and methylcocoate, anionic surfactants, such as sodium 2-ethylhexyl sulphate, 2-ethyl hexyl-phosphate ester, ammonium bis(2-ethyl hexyl)phosphate, ethoxylated 2-ethyl hexyl-phosphate ester and ethoxylated ammonium bis(2-ethyl hexyl)phosphate ester, and combinations thereof.

13. A method of cleaning comprising applying the composition of claim 1 to a surface and removing polystyrene from the surface.

14. A method for the removal of polystyrene from a surface, wherein the method comprises the steps of:
a) providing the composition according to claim 1;
b) treating the surface comprising the polystyrene with the composition provided in step a),
wherein the treatment step b) is performed by the subsequent steps:
contacting the surface with the composition provided in step a); and
removing the composition from the surface.

15. The method according to claim 14, wherein:
step b) is performed by flushing the surface with the composition provided in step a); and/or
step b) is repeated until the removal of polystyrene and/or styrene copolymers is finalized.
